(19) United States
(12) Patent Application Publication
(10) Pub. No.: US 2018/0044560 A1
(43) Pub. Date: Feb. 15, 2018

(54) HIGH TEMPERATURE STABLE, LOW OUTGASSING COMPOSITION, PROTECTIVE TAPE COMPRISING SUCH COMPOSITION AND USE OF SUCH TAPE WITH THIN GLASS

(71) Applicant: CORNING INCORPORATED, CORNING, NY (US)

(72) Inventors: Jennifer Lynn Lyon, Painted Post, NY (US); Paul John Shustack, Elmira, NY (US)

(21) Appl. No.: 15/555,379

(22) PCT Filed: Mar. 2, 2016
(86) PCT No.: PCT/US16/20381

§ 371 Date: Sep. 1, 2017

Related U.S. Application Data
(60) Provisional application No. 62/128,563, filed on Mar. 5, 2015.

(51) Int. Cl. C09J 119/00; C09J 7/02

(52) U.S. Cl. CPC C09J 119/006; C09J 7/02

(57) ABSTRACT

A composition includes a curable material component with a backbone of a completely or substantially completely hydrogenated hydrocarbon based rubber material which is completely or substantially free of carbon-carbon double and triple bonds, a photoinitiator component, and an inert filler. The composition, when cured, is stable at 250C and is low outgassing. A method milling a photoinitiator component and an inert filler with a curable material component to form a precurable mixture and at least partially curing the precurable mixture by ultraviolet light. An apparatus includes a spool, a pressurizer, and an ultraviolet lamp. The spool is configured for releasing a polymer film. The pressurizer is configured to release an adhesive onto the polymer film to form a pre-photo curable adhesive-backed polymer film. The ultraviolet lamp is configured to at least partially cure the pre-photo curable adhesive-backed polymer film.

This application claims the benefit of priority to U.S. Application No. 62/128563 filed on Mar. 5, 2015 the content of which is incorporated herein by reference in its entirety.

### BACKGROUND

The disclosure relates to systems and methods for preparing ultraviolet, visible light or electron beam curable rubbery material, for producing a tape comprising a backing and as an adhesive, the ultraviolet, visible light or electron beam curable rubbery material, and to systems and processes to use a high temperature, low outgassing protective tape for joining and adhering to thin glass webs or sheets.

### SUMMARY

The present disclosure relates, in various embodiments, to a composition of matter. The composition may include components, or a mixture, a blend or a reaction product of a curable material component, a photoinitiator, and an inert filler. The curable material component may comprise a compound having the structure:

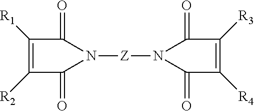

In this structure, Z may be a backbone of a completely or substantially completely hydrogenated hydrocarbon based rubber material which is completely or substantially free of carbon-carbon double and triple bonds (containing less than 7% of carbon-carbon double and triple bonds), R₁, R₂, R₃ and R₄ are, independently, substituted or unsubstituted alkyl, substituted or unsubstituted alkenyl, substituted or unsubstituted alkynyl, aryl, cycloalkyl,

WO 2016/141024 PCT/US2016/020381 aralkyl, amino, ester, aldehyde, hydroxyl, alkoxy, thiol, thioalkyl, halide, acyl halide, or acrylate. Optionally in any embodiment, R₁ and R₂ taken together may form a ring. Optionally in any embodiment, R₃ and R₄ taken together may form a ring. Optionally in any embodiment, the first or second ring of the disclosed structure, or both, may be an aromatic ring with branched double bonds. The photoinitiator component may have substantially no volatility at room temperature and also yield photoproducts after exposure to photo radiation that have minimal or no volatility at room temperature. The composition of matter may be stable at least 250° C. when cured and is low outgassing.

The present disclosure also relates, in various embodiments, to an apparatus for manufacturing high temperature resistant, low outgassing tape. The apparatus may comprise a spool, a pressurizer, and a source of initiation energy, such as an ultraviolet light, for example. The spool may be configured for releasing a polymer film. The pressurizer may be used to release a plurality of adhesives onto the polymer film forming a pre-photo curable adhesive-backed polymer film. The ultraviolet lamp may at least partially cure the pre-photo curable adhesive-backed polymer film.

The present disclosure also relates, in various embodiments, to methods for producing a high temperature resistant, low outgassing matter. The method may be carried out by steps of (a) providing a curable material component comprising a compound having the structure previously stated; (b) milling a photoinitiator component and an inert filler, each as described in this specification, with the curable material component; and (c) at least partially curing the mixture from step (b) by ultraviolet light, wherein the cured composition of matter withstands at least at 250° C.

The present disclosure also relates, in various embodiments, to a method depositing a layer of materials on the web of glass by using a tape. The method may be carried out by connecting the web of glass at an end of a certain length of the tape. The certain length of tape may be fed through a deposition chamber. The method may further include a step of depositing a layer of materials on the web of glass while the web of glass is fed through the deposition chamber.

The present disclosure also relates, in various embodiments, to an adhesive tape. The adhesive tape may comprise an adhesive layer and a backing attached to the first side of the adhesive layer. The adhesive layer may comprise having first and second sides. The adhesive layer may have a curable compound having the structure previously stated, a photoinitiator component and an inert filler as previously stated. The adhesive layer, when cured, may be stable to at least 250° C. and low outgassing.

The present disclosure also relates, in various embodiments, to methods of adhering a backing sheet to a web of glass during high-temperature processing. The method may be carried out by providing a tape comprising a backing sheet having first and second sides and an adhesive layer adhered to at least a portion of the first side. The adhesive layer may have the composition of a curable material component, a photoinitiator component, and an inert filler. The method may be further carried out by adhering the adhesive layer on the first side of the backing sheet to a web of glass, adhering the backing sheet to the glass; and exposing the tape to a processing temperature of at least 250° C. for a period of at least 5 minutes. The tape may remain adhered to the glass through the exposing step.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of an apparatus in use for manufacturing a high temperature resistant tape according to one embodiment.

FIG. 2 is a thermal gravimetrical analysis result on one adhesive according to one embodiment.

FIG. 3 is a gas chromatography-mass spectroscopy (GC-MS) result on one adhesive according to one embodiment.

FIG. 4 is a top view of mechanical testing one adhesive according an embodiment of the method.

FIG. 5 is a side view of mechanical testing one adhesive according an embodiment of the method.

FIG. 6 is a schematic side view of a tape with adhesive layer attached to a thin glass according to an embodiment.

FIG. 7 is a fragmentary transverse section through a glass web, showing an edge tape secured to both faces of the web of glass and bridging a side edge to protect the side edge.

The following reference characters are used in this description and the accompanying drawing figures.

| | |
|---|---|
| 100 | Apparatus |
| 110 | Spool |
| 120 | surface treatment unit |
| 130 | Pressurizer |
| 135 | Housing |
| 140 | Ultraviolet lamp |
| 150 | Release liner |
| 160 | Polymer film |
| 166 | First heater |
| 168 | Second heater |
| 170 | Base plate |
| 172 | Applicator |
| 174 | Adhesive |
| 175 | Precurable adhesive-backed polymer film |
| 180 | Motorized tape take-up roll |
| 600 | Tape |
| 610 | Backing sheet |
| 616 | First side |
| 612 | Second side |
| 620 | Adhesive layer |
| 630 | Web of glass |

### DETAILED DESCRIPTION

The present disclosure can be understood more readily by reference to the following detailed description, drawings, examples, and claims, and their previous and following description. However, before the present compositions, articles, devices, and methods are disclosed and described, it is to be understood that this disclosure is not limited to the specific compositions, articles, devices, and methods disclosed unless otherwise specified, as such can, of course, vary. It is also to be understood that the terminology used herein is for the purpose of describing particular aspects only and is not intended to be limiting.

The following description of the disclosure is provided as an enabling teaching of the disclosure in its currently known embodiments. To this end, those skilled in the relevant art will recognize and appreciate that many changes can be made to the various aspects of the disclosure described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Reference will now be made in detail to the present preferred embodiment(s), examples of which are illustrated in the accompanying drawings. Whenever possible, the same reference numerals will be used throughout the drawings to refer to the same or like parts.

As noted above, broadly, the invention disclosure teaches a composition, a method of making or manufacturing and an apparatus used for making high temperature resistant, low outgassing matter or tape. The composition is made available as an adhesive on a tape that can be attached to the beginning (leading) and/or end (trailing) of the glass roll during roll-to-roll processing of a glass web or ribbon such as, for example, Corning® Willow® Glass. (Willow® is a trademark of Corning Incorporated, Corning, N.Y., USA for a glass sheet that is sufficiently flexible to be processed as a web and formed into a roll.) The tape may serve to enable feeding of the web through the rollers and processing chambers of the roll-to-roll web processing equipment. The tape may be used as an edge tape at one or both side edges of a web of glass.

One issue, as it relates to the tape, is that in some processing steps, the glass web must go through a processing chamber that requires exposure to high temperature and/or high vacuum such as, for example, in Indium Tin Oxide (ITO) deposition. This means that the tape must also be able to maintain adhesion and have minimal outgassing on exposure to those conditions (e.g., 200° C. to 300° C. for up to 15 minutes at 10⁻³ to 10⁻⁵ torr vacuum). It is also important that the tape be silicone-free as silicones can not only contaminate the glass leading to poor adhesion but silicones can also contaminate the ITO deposition chamber. This contamination is nearly impossible to remove and can result in essentially unusable equipment.

The adhesives most commonly used on commercially available high temperature tapes are either silicone or acrylic based. As mentioned above, silicones are unacceptable. The acrylic based adhesives either cannot hold the substrate at the temperature needed (e.g., 200-300° C.) and/or they outgas materials that end up getting deposited on the glass surface, resulting in poor conductivity.

As used herein, the term “low out-gassing” means the cured material, when subjected to ASTM-E-595-93 (1999) Standard Test Method for Total Mass Loss and Collected Volatile Condensable Material from Outgassing in a Vacuum Environment (NASA Reference Publication No. 1124) exhibits a Total Mass Loss of less than 2.00%, a Collected Volatile Condensable Materials of less than 0.20% and a Water Vapor Regain of less than 0.40%.

As used herein, the term “rubbery” or “low modulus” means that the cured material has a Young's modulus ranging from 25 to 10,000 psi (about 170k Pa to about 70 M Pa) at room temperature. A rubber material in the present application is a material that is rubbery.

As used herein, “room temperature” means 25° C. “About room temperature” means room temperature ±20° C.

As used herein, “the composition, when cured, stable at 250 ° C,” means that the composition maintains adhesion between glass and polyimide with less than or equal to 2 mm displacement after exposure to 250° C. for 15 minutes under a stress of 6 N/3.5 m² and is low outgassing.

As used herein, a material “based on completely or substantially completely hydrogenated hydrocarbon based rubber material” means the material has a backbone structure at least part of which comprises one or more hydrocarbons that are completely or substantially completely hydrogenated. As used herein, “a completely or substantially completely hydrogenated hydrocarbon based rubber material” may mean the rubber material is completely or substantially free of carbon-carbon double and triple bonds (e.g., contains no more than 7% of carbon-carbon double and triple bonds). The material may comprise, however, terminal or pendant groups that are not completely hydrocarbon or completely hydrogenated.

A composition of high temperature resistant, low outgassing matter may comprise the following components, or a mixture or a reaction product thereof: a curable material component, a photoinitiator component, and an inert filler. The composition may be high-temperature resistant, and may withstand at least 250° C. after it is cured. The curable material component may comprise a compound having the structure:

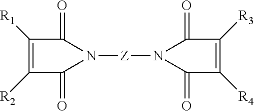

In this structure, Z is a backbone of a completely or substantially completely hydrogenated hydrocarbon based rubber material. The rubber may be based on, for example, polybutadiene, polyisoprene, polyethylene propylene rubber (EPR), and combinations thereof, and the like. The rubber material may be completely or substantially free of carbon-carbon double and triple bonds. Normally, this is achieved by hydrogenation of the rubber backbone. The hydrogenated rubber materials are functionalized with at least one group that renders the rubber molecules polymerizable. The polymerizable group on the hydrogenated rubber may be terminal or pendant, as disclosed in U.S. Pat. No. 7, 256, 221. Optionally in some embodiments, Z does not have an ether or epoxy group. Polymers having an ether or epoxy group may break down to aldehyde, carboxylic acid at high temperature. In addition, polymers with an ether or epoxy linkage may tend to be oxidized easily. Examples of polymerizable groups may include maleimide, phthalimide, and their derivatives, for example

In one embodiment, R₁, R₂, R₃ and R₄ may be, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, or acrylate. Optionally in any embodiment, one of I) or II) may be present, wherein I) refers that R₁ and R₂ may combine to form a ring, such as six-member or five-member ring. The condition of II may refer that R₃ and R₄ combine to form a ring, such as six-member or five-member ring. Conditions I and II may coexist in one molecule, in which R₁ and R₂ may combine to form a first ring and R₃ and R₄ may combine to form a second ring. Optionally in some embodiments, either ring independently may be an aromatic ring. Optionally in some embodiments, the first and second ring may be each an aromatic ring.

The composition of matter may further include a photoinitiator. The photoinitiator component may have substantially no volatility at room temperature and also may yield photoproducts after exposure to photo radiation that have minimal or no volatility at room temperature. For example, the collected volatile condensable materials from photo products after exposure to photo radiation may be less than 0.2% at room temperature. The photoinitiator may be selected from the group consisting of the following compounds and/or mixtures in purified and/or diluted form: oligo [2-hydroxy-2-methyl-1-[4-(1-methylvinyl)phenyl]propanone]; oligo [2-hydroxy-2-methyl-1-[4-(1-methylvinyl) phenyl]Propanone], diluted in tripropylene glycol diacrylate (25% TPGDA);1-[4-(4-benzoylphenylsulfonyl)phenyl]-2-methyl-2-(4-methylphenylsulfonyl) propan-1-one; bis(2,4,6-trimethylbenzoyl)-Phenyl phosphine oxide; 2-benzyl-2-N,N-dimethylamino-1-(4-morpholino-phenyl)-1-butanone; bis η5-(2,6-cyclopentadien-1-yl) bis(2,6-difluoro-3-(1H-pyrrol-1 -yl) phenyl)titanium; bis (2,6-dimethoxybenzoyl)-2,4,4-trimethylpentyl phosphine oxide; 2-oxepanone, homopolymer, 2- [[4- [2-methyl-2-(4-morpholinyl)-1-oxopropyl]phenyl]thio]ethyl ester; mixture of 2-isopropylthioxanthone and 4-isopropylthioxanthone; 1,3-dimethyl-2-hydroxy-9H-thioxanthen-9-one, 2-ethylhexyl ester; 4,4′-bis(methylethylamino)benzophenone; 4,4′-bis(isopropylphenoxy)benzophenone; 4-benzoyl-4′-methyldiphenyl sulfide; 2-chloro-thioxanthone; 1-chloro-4-propoxythioxanthone; 2,4-diethylthioxanthone; poly[oxy(methyl-1,2-ethanediyl)], α- [4-(dim ethylamino)benzoyl-ω-butoxy-; 2,2′-bis-(2-chlorophenyl)-4,5,4′,5′-tetraphenyl-2′H-<1,2′>biimidazolyl; (tolylcumyl)iodonium tetrakis(pentafluorophenyl) borate; [4-[(2-hydroxytetradecyl)oxy]phenyl]phenyliodonium hexafluoro antimonate; mixture of bis(4-dodecylphenyl)iodonium hexafluoroantimonate, isopropylthioxanthone, and C12+C14 alkylglycidyl ethers; mixture of bis(4-dodecylphenyl)iodonium hexafluoroantimonate and C12+C14 alkylglycidyl ethers; phenyl-4-octyloxyphenyl iodonium hexafluoro antimonate; mixture of triaryl sulfonium hexafluoroantimonate salts; mixture of triaryl sulfonium hexafluorophosphate salts; 5,7-diiodo-3 -butoxy-6-fluorone; (4-octyloxy)phenyl(phenyl)iodonium hexafluoroantimonate; Butylryl choline butyl triphenyl borate; perylene; anthracene; 1,2-benzanthracene; 9-n-butoxyanthracene; 9,10-di-n-butoxy anthracene; 9,10-di-n-propoxy anthracene; 9,10-diethoxy anthracene; anthrone; pyrene; 2-ethyl-9,10-dimethoxy anthracene; 2,5-diphenyl-1,3 ,4-oxadiazole; diphenyl anthracene; 9,10-dimethylanthracene; 1,3 -diphenyl-2-pyrazoline; 1,3-diphenylisobenzofuran; N,N,N′,N′-tetraphenyl benzidine; and N,N,N′,N′-tetraphenyl phenylene diamine; and compatible mixtures thereof and/or compatible combinations thereof. In one embodiment, the photoinitiator may include Irgacure 819 from BASF Corp., for example. In any embodiment, the photoinitiator may include at least one co-initiator. The co-initiator may include (4-octyloxy) phenyl (phenyl) iodonium hexafluoroantimonate, or butylryl choline butyl triphenyl borate, for example.

Optionally in some embodiments, the photoinitiator comprises a visible-light photoinitiator. For example, the visible-light photoinitiator may comprise 5,7-diiodo-3-butoxy-6-fluorone.

The composition of the matter may further include an inert filler. The inert filler may comprise, for example, an inorganic filler selected from the group consisting of alumina, crystobalite, aluminum trihydroxide, talc, feldspar, calcium carbonate, mica, clay, wallastonite, nepeleline syenite, silica, and compatible mixtures thereof and compatible combinations thereof. Other suitable fillers can also be used, and are expressly contemplated. The particle size of fillers may be from about 1 nm to about 1 mm, for example. In one embodiment, the particle size of fillers may be from 10 nm to about 0.5 mm, for example. In another embodiment, the particle size of fillers may be from 100 nm to about 0.1 mm, for example. The silica filler may comprise spherical silica filler, for example. The spherical silica filler may have about 0.5 micron diameter spherical shape, for example. The composition of the matter may be free or substantially free of silicone. For example, the composition of matter may comprise at most about 0.001% by weight silicone.

In one embodiment, the composition of matter may comprise from about 45 wt. % to about 55 wt. % of the curable material component, from about 45 wt. % to about 55 wt. % of the filler, and at least about 0.1 wt. % of the photoinitiator. In another embodiment, the curable material component may be less than 45 wt. %. In still another embodiment, the curable material component may be more than 55 wt. %.

For example, the composition 16046-135-1 may comprise:

Composition 16046-135-1

| Percent by | Ingredient | | |
|---|---|---|---|
| Weight (%) | Trade Name | Ingredient Type | Vendor |
| 44.90 | FM28-42 | Maleimide functional | Designer |
| | | hydrogenated rubber | Molecules Inc. |
| 55.00 | SIO2-P050-01 | 0.5 μm diameter | Particle |
| | | spherical silica filler | Solutions LLC |
| 0.10 | Irgacure 819 | Photoinitiator | BASF Corp. |

The maleimide—based hydrogenated rubber formulations, such as the samples of 16046-135-1 formulation, passed NASA outgas testing (ASTM E595-07) which exposes cured samples to 125° C. for 24 hours under vacuum at 5×10⁻⁵ torr. The samples of 16046-135-1 formulation did quite well with 0.141% total mass loss (Spec. is 1% max) and 0.021% collected volatile condensable materials (Spec is 0.1% max). The material did well also on oxidative induction temperature (OIT) testing by TGA/DSC in both air and nitrogen.

In another embodiment, the composition 16046-154-2 may include the following formulation:

Composition 16046-154-2

| Percent | | | |
|---|---|---|---|
| by | | | |
| Weight | Ingredient | | |
| (%) | Trade Name | Ingredient Type | Vendor |
| 54.90 | FM28-44 | Maleimide functional | Designer |
| | | hydrogenated rubber | Molecules Inc. |
| 45.00 | SIO2-P050-01 | 0.5 μm diameter | Particle Solutions LLC |
| | | spherical silica filler | |
| 0.10 | Irgacure 819 | Photoinitiator | BASF Corp. |

In yet another embodiment, the composition 16646-22-1 may include:

Composition 16646-22-1

| Percent | | | |
|---|---|---|---|
| by | | | |
| Weight | Ingredient | | |
| (%) | Trade Name | Ingredient Type | Vendor |
| 49.90 | FM28-55A | Maleimide functional | Designer |
| | | hydrogenated rubber | Molecules Inc. |
| 50.00 | SIO2-P050-01 | 0.5 μm diameter | Particle Solutions LLC |
| | | spherical silica filler | |
| 0.10 | Irgacure 819 | Photoinitiator | BASF Corp. |

In still another embodiment, the composition 16646-142-1 may further include about 49 wt. % maleimide functional hydrogenated rubber as the curable material component, about 50 wt. % silica as the inert filler, about 0.2 wt. % 5,7-diiodo-3-butoxy-6-fluorone (also known as H-Nu 470) as a visible light-photoinitiator, about 0.3 wt. % ((4-octyloxy)phenyl(phenyl)iodonium hexafluoro antimonate) and about 0.3 wt. % butyryl choline butyl triphenyl borate as co-initiators, as shown in the following table:

| Percent by | Ingredient | | | |
|---|---|---|---|---|
| Weight (%) | Trade Name | Ingredient Type | Chemical name | Vendor |
| 49.25 | FM28-55A | Maleimide functional | | Designer Molecules Inc. |
| | | hydrogenated rubber | | |
| 50.00 | SIO2-P050-01 | 0.5 μm diameter spherical silica filler | | Particle Solutions LLC |
| 0.15 | H-Nu 470 | Visible light photoinitiator | 5,7-diiodo-3-butoxy-6-fluorone | Spectra Group Limited Inc. |
| 0.30 | OPPt | Co-initiator | (4-octyloxyphenyl)phenyliodonium | Hampford Research Inc. |
| | | | hexafluoroantimonate | |
| 0.30 | Borate V | Co-initiator | butyryl choline butyltriphenylborate | Spectra Group Limited Inc. |

A different photoinitiator package may be developed to enable curing with light >500 nm wavelength. Spectra Group's visible light photoinitiator H-Nu 470 has the spectral absorbance peak around 470 nm.

The combination of H-Nu 470 photoinitiator with a co-initiator OPPI ((4-octyloxy)phenyl(phenyl)iodonium hexafluoro antimonate) and borate V (butyryl choline butyl triphenyl borate) may enable pre-cure and then subsequent full cure with a Xenon UV flash lamp. The full cure may be done through the polyimide film. The composition of matter may form a strong bonding with polyimide tape and thin glass, such as alkali-free borosilicate glass. For examples, the composition of matter exhibits less than 0.4 mm slippage or displacement on the thin glass when exposed to 2N/inch (0.8 N/cm) force under 250° C. for 10 hours.

In some embodiments, the composition of matter, either alone or secured to a suitable backing to form a tape, forms a strong bond with thin, flexible glass, such as a thin sheet or web of alkali-free borosilicate glass.

In various embodiments, the disclosure teaches an adhesive tape. The adhesive tape may include an adhesive layer and a backing attached to the first side of the adhesive layer. The adhesive layer may include first and second sides. The adhesive layer may comprise a curable compound, a photoinitiator, and an inert filler. The curable compound may have the same polyimide structure as disclosed before. The photoinitiator component and the inert filler may have the same structure or composition as described before. The adhesive layer, when cured, may be stable, low outgassing, and may withstand at least 250° C. The backing may also be a stable, non-silicone polymer, such as a polyimide polymer.

Polyimide or Kapton may be the polymer film of choice for making high temperature tapes because it may hold up to high temperature, and is low outgassing, and is commercially available in thin (0.5 to 5 mil) films suitable for making tapes.

A method for producing a composition of matter comprises steps of providing a curable material component, a compound having the structure previously stated; milling a photoinitiator component and an inert filler with the curable material component, forming a precurable mixture; at least partially curing the precurable mixture by a source of initiation energy, such as ultraviolet light, forming at least partially cured materials. The cured material may be stable (at least at 250° C.), optionally from 200° C. to 350° C., and may be low outgassing. The photoinitiator and the filler were also previously stated. The precurable mixture may be a mixture of components (e.g., the curable material component, the photoinitiator component, and the inert filler) prior to curing. Thus, the precurable mixture may be a curable mixture.

The method may further include a step of fully curing the composition of matter under ultraviolet light; heating the precurable mixture to at least 60° C. so that the precurable mixture becomes liquid; spreading the precurable mixture onto a polyimide tape before at least partially curing the precurable mixture. The cured composition of matter may be substantially free of silicone. Optionally, the backbone Z may not have an ether or epoxy group.

In one embodiment, the method further comprises heating the precurable mixture to at least 60° C. so that viscosity of the precurable mixture may drop to a workable level.

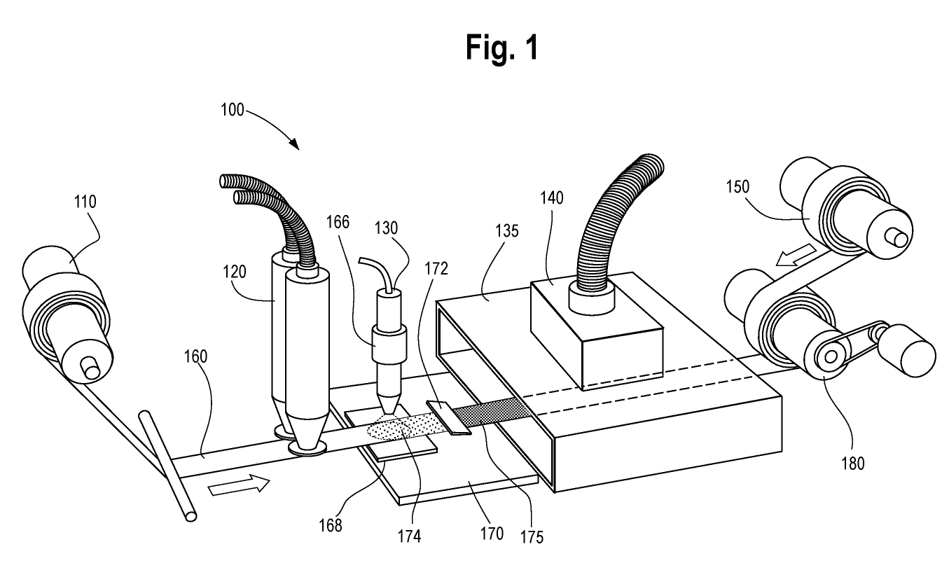

As shown in FIG. 1, an apparatus 100 for manufacturing high temperature stable (at least at 250° C.), low outgassing tape may comprise a spool 110, a pressurizer 130, and a source of initiation energy, such as an ultraviolet lamp 140. The spool may be configured for releasing a polymer film 160, such as polyimide film. The pressurizer 130, such as a pressurized syringe, may be designed for releasing an adhesive 174 onto the polymer film 160 forming a precurable adhesive backed polymer film 175. The ultraviolet lamp 140 may at least partially cure the precurable adhesive-backed polymer film 175 in a housing 135. The housing 135 may be designed for providing a venue for at least partially curing the precurable adhesive-backed polymer film 175.

The polymer may be a Kapton® film, which may be high temperature resistant tape (Kapton® is a registered trademark of E. I. du Pont de Nemours and Co., Wilmington, Del. for polyimide film). The adhesive 174 may include a curable material component, a photoinitiator component, and an inert filler. The curable material component may, as previously described, have a backbone of a completely or substantially completely hydrogenated hydrocarbon based rubber material which is completely or substantially free of carbon-carbon double and triple bonds (e.g., containing no more than 7% of carbon-carbon double and triple bonds). The photoinitiator and the inert filler were also similarly described as before.

The apparatus 100 may further include an applicator 172, such as a bird applicator, which is designed for spreading the adhesive 174 onto the polymer film 160. The apparatus 100 may include a surface treatment unit 120, which is designed for cleaning the polymer film before the pressurizer 130 releases the adhesive 174. The adhesive 174 may be stored in the pressurizer 130 and may be heated by a first heater 166, such as a band heater. The apparatus 100 may further include a release liner 150, which is designed for releasing a film covering the at least partially cured adhesive-backed polymer film. The apparatus 100 may further include a second heater 168, such as a mat heater, which is designed for heating a base plate 170 and/or the applicator 172. The base plate 170 may be designed for supporting the adhesive 174 released by the pressurizer 130 to the polymer film 160. The apparatus 100 may further include a take-up roll such as a motorized tape take-up roll 180, for example. The motorized tape take-up roll 180 may be designed for storing the partially cured adhesive backed polymer film.

In operation, the polymer film 160 may come from the spool 110 and may be treated with two surface treating units 120, such as Enercon Dyne-A-Mite HP atmospheric corona surface treating units. The surface treatment may modify (e.g., increase or decrease) the surface energy allowing the adhesive 174 to adhere to the polymer film 160. The adhesive 174 may be heated to about 60° C. with a first heater 166, such as a band heater, wrapped around the pressurizer 130. The first heater 166 may be connected to a temperature controller with a thermocouple (not shown) to control the temperature. Higher temperature, such as 60° C. may lower the viscosity of the adhesive 174 to a dispensable level. The adhesive 174 may be dispensed from the pressurizer 130, such as a syringe, using, for example, an EFD model 1500-DV dispenser at 10 pounds per square inch (psi) (70 kPa).

The adhesive may be spread across the polymer tape using a 1 mil (25 micron) applicator 172. The applicator 172 and the base plate 170, such as a stainless steel base plate, may also be heated to 60° C. with a mat heater 168. After exiting the applicator 172, the adhesive 174 may form a 1 mil (25 μm) thick uniform layer of adhesive over the polyimide film. Next, the polymer film 160 with adhesive 174 may travel under an energy source such as, for example, a XENON RC-600 pulsed UV lamp 140 to be partially cured. The lamp 140 may be located 2 inches (5 cm), for example, above the adhesive covered polymer film. The adhesive covered polymer film can travel under the lamp 140 at a rate of 1.46 ft./min, for example. The partially cured adhesive may be referred to as B-staged. The adhesive may be slightly tacky at this point, for example. After the adhesive is B-staged, a release liner such as, for example, a 5 mil FEP release liner film from the release liner 150, may be applied on top of the adhesive to prevent the adhesive adhering to the backside of the polyimide film as it is wound onto a take-up roll 180. The tape may be stored at room temperature in a dark cabinet. The tape may have a 6 month shelf life, for example.

When making adhesion testing samples or for other purposes, the tape may be applied to glass and then fully UV cured through the polyimide side of the tape. The cure may be completed with a XENON UV light (Model LH-810 1910 configuration, 107 mm spiral-3 m, high powered, 12 pulses per second lamp). In one embodiment, the exposure time may be 30 seconds with the face on the lamp 0.25 inch (6 mm) away from the polyimide tape. In another embodiment, the exposure time may be 15 seconds with the face on the lamp 0.25 inch (6 mm) away from the polyimide tape, for example.

In one embodiment, a method of depositing a layer of materials on the web of glass by using a tape may comprise steps of connecting the web of glass at an end of a certain length of the tape, such as polyimide type; feeding through the certain length of tape, such as polyimide type, through a deposition chamber; and depositing a layer of materials on the web of glass while the web of glass is fed through the deposition chamber.

In one embodiment, the tape may be a high-temperature, high vacuum resistant polyimide tape. The tape may comprise low outgassing, non-silicone adhesives. The layer of deposited materials may be indium tin oxide (ITO). The method may further include a step of reaching a determined temperature, such as about 250° C., when the web of glass moves into the deposition chamber.

Leaders and trailers made of the tape may have a 5 mil (125 microns) thick polyimide film that may be the same width as the thin glass, such as the Willow® glass with a length of about 30 meters, for example. Alternatively, the leaders and trailers may not be the same width as the thin glass. The polyimide may be attached to the beginning (leader) and ending (trailer) of a roll of the thin glass with an adhesive tape. Alternatively, the adhesive may be applied to a small section of the leaders and/or trailer tapes to adhere them to the web of glass. The adhesive tape may be made of curable materials, photoinitiator, and an inert filler, for example. The web of glass, which may be a roll of glass, for example, may then be put through a process in which indium tin oxide is deposited on the surface of the thin glass. The indium tin oxide may be deposited for its high electrical conductivity while maintaining optical transparency, thus enabling its use for displays, touch panels, and thin film transistors.

Leaders may be useful in the process because they may minimize glass waste. In the deposition chamber, the leader may be fed through the chamber first, which may require about a 28 meter polyimide leader, for example. As the leader is fed through the deposition chamber, the temperature in the chamber may reach an optimum temperature of 250° C. Prior to reaching this temperature, the deposition chamber may start to deposit indium tin oxide. A higher temperature, such as 250° C. to 300° C., may produce coatings with lower resistivity and higher optical transparency. The target of the resistivity may be 50Ω/sq. By feeding the polyimide leader through the chamber first, optimum deposition may be reached by the time the glass reaches the process. Trailers are similarly useful to allow the following end of the glass sheet to be fed properly through the machine, facilitating process near the end of the glass sheet.

In another embodiment, as shown in FIG. 6, a method of adhering a backing sheet to a web of glass (or roll-to-roll glass) during high-temperature processing may be carried out by providing a tape 600 comprising a backing sheet 610 having first side 616 and second side 612 and an adhesive layer 620 adhered to at least a portion of the first side 616. The adhesive layer 620 may have the composition of a curable material component, a photoinitiator component, and an inert filler as described herein. The adhesive layer 620 on the first side 616 of the backing sheet 610 may then be adhered to a web of glass 630 to adhere the backing sheet 610 to the glass 630. The adhered adhesive layer 620 may be exposed to a processing temperature of at least 250° C. for a period of at least 5 minutes. Going through the exposing step, the tape 600 may remain adhered to the glass. In one embodiment, the adhering step may further be carried out by contacting the adhesive layer on the first side of the backing sheet to a web of glass and pressing the adhesive layer to the web of glass; at least partially curing the curable material component under an ultraviolet lamp; and fully curing the curable material component through the second side of the backing sheet of the tape to a soft, thermoset rubber. The soft, thermoset nature may be desirable here to prevent flow at the high usage temperature.

The method of adhering a backing sheet to a web of glass during high-temperature processing may be further carried out by peeling off a release liner before adhering the adhesive layer on the first side of the backing sheet to the web of glass.

Other embodiments may be carried out by adhering the adhesive layer on the first side of the backing sheet to a trailing end of one web of glass and also to a leading edge of another web of glass; and adhering the adhesive layer on the first side of the backing sheet on at least one side edge of the web of glass forming an edge tape.

Other embodiments may be carried out to apply an edge tape to one or both side edges of a sheet or web of glass to protect the side edges. As shown in FIG. 7, the web of glass 630 may include an upper surface 634, a lower surface 636, and an edge 638. The tape 600 may bridge or be wrapped around the edge 638 of the web of glass 630 and cover at least a partial upper surface 634 and at least a partial lower surface 636. In one embodiment, equal length of the tape 600 may cover a partial upper surface 634 and a partial lower surface 636. In another embodiment, unequal length of the tape 600 may be used to cover the upper surface 634 as to cover the lower surface 636.

The edge tape 600 may cover a full length of the glass on either sides, or a full length of the glass web on one side, or a partial length of the glass web on one or both sides. In one embodiment, the edge tape may be 1 to 2 inch (2 to 5 cm) wide and applied to a substantially wide glass web, such as a 24 inch (about 60 cm) wide web of glass. The edge tape may be folded so one portion is on the upper surface 634, the other portion is on the lower surface 636, and an intermediate portion is wrapped or bridges around at least one edge 638 of the web of glass. In another embodiment, the edge tape may be wider than 1 or 2 inches. In further another embodiment, the edge tape may be narrower than 1 or 2 inches. The edge tape may be folded in various ways covering at least one edge of the web of glass.

A useful purpose of the edge tape is protection. Cracks in glass propagate from a defect in the glass web. Quite often these cracks may start at an edge defect. The edge tape also may supply some added strength should the glass experience any level of torsion during the process. In addition, the edge tape raises the glass slightly off the drums in the chamber, minimizing contact and possible damage. The backing in the method may be a high temperature resistant, low outgassing polymer, such as a polyimide polymer. The tape may be substantially free of silicone.

The tape may form a strong bonding with thin glass, such as alkali-free borosilicate, even under high temperature such as, for example, at least 250° C., and vacuum. In one embodiment, the process may include a step of depositing a layer of material onto the web of glass. The layer of material may comprise indium tin oxide.

In some embodiments, a composition of matter comprises the following components or a mixture or a reaction product thereof: a curable material component comprising a compound having the structure:

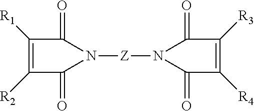

wherein Z is a backbone of a completely or substantially completely hydrogenated hydrocarbon based rubber material, and R₁, R₂, R₃ and R₄ are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, or acrylate; a photoinitiator component having substantially no volatility at room temperature and yielding photoproducts after exposure to photo radiation, the photoproducts having substantially no volatility at room temperature; and an inert filler. The composition, when cured, is stable at 250° C. and is low outgassing. R₁ and R₂ may combine to form a ring. R₃ and R₄ may combine to form a ring. The inert filler may comprise an inorganic filler selected from the group consisting of alumina, crystobalite, aluminum trihydroxide, talc, feldspar, calcium carbonate, mica, clay, wallastonite, nepeleline syenite, silica, compatible mixtures thereof, and compatible combinations thereof. The photoinitiator may comprise at least one compound selected from the group consisting of: oligo [2-hydroxy-2-methyl-1-[4-(1-methylvinyl)phenyl]propanone]; oligo [2-hydroxy-2-methyl-1-[4-(1-methylvinyl)phenyl]propanone], diluted in tripropylene glycol diacrylate (25% TPGDA); 144-(4-benzoylphenylsulfonyl)phenyl]-2-methyl-2-(4-methylphenylsulfonyl) propan- 1-one; bis(2,4,6-trimethylbenzoyl)-phenyl phosphine oxide; 2-benzyl-2-N,N-dimethylamino-1-(4-morpholino-phenyl)-1-butanone; bis η5-(2,4-cyclopentadien-1-yl) bis(2,6-difluoro-3-(1H-pyrrol-1-yl) phenyl)titanium; bis (2, 6-dimethoxybenzoyl)-2,4,4-trimethylpentyl phosphine oxide; 2-oxepanone, homopolymer, 2-[[4-methyl-2-(4-morpholinyl)-1-oxopropyl]phenyl]thio]ethyl ester; 2-isopropylthioxanthone;

4-isopropylthioxanthone; 1,3-dimethyl-2-hydroxy-9H-thioxanthen-9-one, 2-ethylhexyl ester; 4,4′-bis(methylethylamino)benzophenone; 4,4′-bis(isopropylphenoxy)benzophenone; 4-benzoyl-4′-methyldiphenyl sulfide; 2-chloro-thioxanthone; 1-chloro-4-propoxythioxanthone; 2,4-diethylthioxanthone; poly[oxy(methyl-1,2-ethanediyl)], α-[4-(dimethylamino)benzoyl-ω-butoxy-; 2,2′-bis-(2-chlorophenyl)-4,5,4′, 5′-tetraphenyl-2′H-<1,2′>biimidazolyl; (tolylcumyl)iodonium tetrakis(pentafluorophenyl) borate; [4-[(2-hydroxytetradecyl)oxy]phenyl]phenyliodonium hexafluoro antimonate; bis(4-dodecylphenyl)iodonium hexafluoroantimonate; isopropylthioxanthone; C12+C14 alkylglycidyl ethers; phenyl-4-octyloxyphenyl iodonium hexafluoro antimonate; triaryl sulfonium hexafluoroantimonate salts; mixture of triaryl sulfonium hexafluorophosphate salts; 5,7-diiodo-3-butoxy-6-fluorone; perylene; anthracene; 1,2-benzanthracene; 9-n-butoxyanthracene; 9,10-di-n-butoxy anthracene; 9,10-di-n-propoxy anthracene; 9,10-diethoxy anthracene; anthrone; pyrene; 2-ethyl-9,10-dimethoxy anthracene; 2,5-diphenyl-1,3,4-oxadiazole; diphenyl anthracene; 9,10-dimethylanthracene; 1,3-diphenyl-2-pyrazoline; 1,3-diphenylisobenzofuran; N,N,N′,N′-tetraphenyl benzidine; and N,N,N′,N′-tetraphenyl phenylene diamine; compatible mixtures thereof; and compatible combinations thereof. The composition may be substantially free of silicone. The photoinitiator may comprise a visible light photoinitiator. The visible light photoinitiator may comprise 5, 7-diiodo-3-butoxy-6-fluorone. Z may not have an ether group. The composition may comprise at least about 45 wt. % of the curable material component, at least about 45 wt. % of the filler, and at least about 0.10 wt. % of the photoinitiator. The inert filler may comprise spherical silica. The photoinitiator may comprise at least one co-initiator. Z may not have epoxy group. The composition may comprise about 49 wt. % maleimide functional hydrogenated rubber as the curable material component; about 50 wt. % silica as the inert filler; about 0.2 wt. % 5,7-diiodo-3-butoxy-6-fluorone as a visible light-photoinitiator; and about 0.3 wt. % ((4-octyloxy)phenyl(phenyl)iodonium hexafluoro antimonate) and about 0.3 wt. % butyryl choline butyl triphenyl borate as co-initiators.

In some embodiments, a method for producing a composition of matter comprises (a) milling a photoinitiator component and an inert filler with a curable material component to form a precurable mixture, the curable material component comprising a compound having the structure

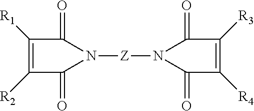

wherein Z is a backbone of a completely or substantially completely hydrogenated hydrocarbon based rubber material, and R₁, R₂, R₃ and R₄ are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, or acrylate; and (b) at least partially curing the precurable mixture by ultraviolet light forming an at least partially cured material, wherein the at least partially cured material is stable at least at 250° C. and is low outgassing. R₁ and R₂ may combine to form a first ring. R₃ and R₄ may combine to form a second ring. The method may comprise fully curing the at least partially cured material by ultraviolet light. The method may comprise spreading the precurable mixture onto a polyimide tape before at least partially curing the precurable mixture. The at least partially cured material may be substantially free of silicone. Z may not have an ether group or an epoxy group. The photoinitiator may comprise at least one compound selected from the group consisting of: oligo [2-hydroxy-2-methyl-1-[4-(1-methylvinyl)phenyl]propanone]; oligo [2-hydroxy-2-methyl-1-[4-(1-methylvinyl)phenyl]propanone], diluted in tripropylene glycol diacrylate (25% TPGDA); 1-[4-(4-benzoylphenylsulfonyl)phenyl]-2-methyl-2-(4-methylphenylsulfonyl) propan-1-one; bis(2,4,6-trimethylbenzoyl)-phenyl phosphine oxide; 2-benzyl-2-N,N-dimethylamino-1-(4-morpholino-phenyl)-1-butanone; bis η5-(2,4-cyclopentadien-1-yl) bis(2,6-difluoro-3-(1H-pyrrol-1-yl) phenyl)titanium; bis (2, 6-dimethoxybenzoyl)-2,4,4-trimethylpentyl phosphine oxide; 2-oxepanone, homopolymer, 2-[[4-[2-methyl-2-(4-morpholinyl)-1-oxopropyl]phenyl]thio]ethyl ester; 2-isopropylthioxanthone; 4-isopropylthioxanthone; 1,3-dimethyl-2-hydroxy-9H-thioxanthen-9-one, 2-ethylhexyl ester; 4,4′-bis(methylethylamino)benzophenone; 4,4′-bis(isopropylphenoxy)benzophenone; 4-benzoyl-4′-methyldiphenyl sulfide; 2-chloro-thioxanthone; 1-chloro-4-propoxythioxanthone; 2,4-diethylthioxanthone; poly[oxy(methyl-1,2-ethanediyl)], α-[4-(dimethylamino)benzoyl-ω-butoxy-; 2,2′-bis-(2-chlorophenyl)-4,5,4′, 5′-tetraphenyl-2′H-<1,2′>biimidazolyl; (tolylcumyl)iodonium tetrakis(pentafluorophenyl) borate; [4-[(2-hydroxytetradecyl)oxy]phenyl]phenyliodonium hexafluoro antimonate; bis(4-dodecylphenyl)iodonium hexafluoroantimonate; isopropylthioxanthone; C12+C14 alkylglycidyl ethers; phenyl-4-octyloxyphenyl iodonium hexafluoro antimonate; triaryl sulfonium hexafluoroantimonate salts; triaryl sulfonium hexafluorophosphate salts; 5,7-diiodo-3-butoxy-6-fluorone; perylene; anthracene; 1,2-benzanthracene; 9-n-butoxyanthracene; 9,10-di-n-butoxy anthracene; 9,10-di-n-propoxy anthracene; 9,10-diethoxy anthracene; anthrone; pyrene; 2-ethyl-9,10-dimethoxy anthracene; 2,5-diphenyl-1,3,4-oxadiazole; diphenyl anthracene; 9,10-dimethylanthracene; 1,3-diphenyl-2-pyrazoline; 1,3-diphenylisobenzofuran; N,N,N′ ,N′-tetraphenyl benzidine; and N,N,N′ ,N′-tetraphenyl phenylene diamine; compatible mixtures thereof; and compatible combinations thereof.

In some embodiments, an adhesive tape comprises an adhesive layer having first and second sides and a backing attached to the first side of the adhesive layer. The adhesive layer comprises a curable compound having the structure:

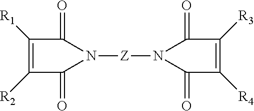

wherein Z is a backbone of a completely or substantially completely hydrogenated hydrocarbon based rubber material, and R₁, R₂, R₃ and R₄ are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, or acrylate; a photoinitiator component having substantially no volatility at room temperature and yielding photoproducts after exposure to photo radiation, the photoproducts having substantially no volatility at room temperature; and an inert filler. The adhesive layer, when cured, is stable from 250° C. to 350° C. and is low outgassing. R₁ and R₂ may combine to form a ring. R₃ and R₄ may combine to form a ring. The adhesive tape may comprise a release liner attached to the second side of the adhesive layer. Z may not have an ether group or an epoxy group. The inert filler may comprise an inorganic filler selected from the group consisting of alumina, crystobalite, aluminum trihydroxide, talc, feldspar, calcium carbonate, mica, clay, wallastonite, nepeleline syenite, silica, compatible mixtures thereof, and compatible combinations thereof. The photoinitiator may comprise at least one compound selected from the group consisting of: oligo [2-hydroxy-2-methyl-1-[4-(1-methylvinyl)phenyl]propanone]; oligo [2-hydroxy-2-methyl-1-[4-(1-methylvinyl)phenyl]propanone], diluted in tripropylene glycol diacrylate (25% TPGDA); 1-[4-(4-benzoylphenylsulfonyl)phenyl]-2-methyl-2-(4-methylphenylsulfonyl) propan-1-one; bis(2,4,6-trimethylbenzoyl)-phenyl phosphine oxide; 2-benzyl-2-N,N-dimethylamino-1-(4-morpholino-phenyl)-1-butanone; bis η5-(2,4-cyclopentadien-1-yl) bis(2,6-difluoro-3-(1H-pyrrol-1-yl) phenyl)titanium; bis (2,6-dimethoxybenzoyl)-2,4,4-trimethylpentyl phosphine oxide; 2-oxepanone, homopolymer, 2-[[4-[2-methyl-2-(4-morpholinyl)-1-oxopropyl]phenyl]thio]ethyl ester; 2-isopropylthioxanthone; 4-isopropylthioxanthone; 1,3-dimethyl-2-hydroxy-9H-thioxanthen-9-one, 2-ethylhexyl ester; 4,4′-bis(methylethylamino)benzophenone; 4,4′-bis(isopropylphenoxy)benzophenone; 4-benzoyl-4′-methyldiphenyl sulfide; 2-chloro-thioxanthone; 1-chloro-4-propoxythioxanthone; 2,4-diethylthioxanthone; poly[oxy(methyl-1,2-ethanediyl)], α-[4-(dimethylamino)benzoyl-ω-butoxy-; 2,2′-bis-(2-chlorophenyl)-4,5,4′,5′-tetraphenyl-2′H-<1,2′>biimidazolyl; (tolylcumyl)iodonium tetrakis(pentafluorophenyl) borate; [44(2-hydroxytetradecyl)oxy]phenyl]phenyliodonium hexafluoro antimonate; bis(4-dodecylphenyl)iodonium hexafluoroantimonate; isopropylthioxanthone; C12+C14 alkylglycidyl ethers; phenyl-4-octyloxyphenyl iodonium hexafluoro antimonate; triaryl sulfonium hexafluoroantimonate salts; triaryl sulfonium hexafluorophosphate salts; 5,7-diiodo-3-butoxy-6-fluorone; perylene; anthracene; 1,2-benzanthracene; 9-n-butoxyanthracene; 9,10-di-n-butoxy anthracene; 9,10-di-n-propoxy anthracene; 9,10-diethoxy anthracene; anthrone; pyrene; 2-ethyl-9,10-dimethoxy anthracene; 2,5-diphenyl-1,3,4-oxadiazole; diphenyl anthracene; 9,10-dimethylanthracene; 1,3-diphenyl-2-pyrazoline; 1,3-diphenylisobenzofuran; N,N,N′,N′-tetraphenyl benzidine; and N,N,N′,N′-tetraphenyl phenylene diamine; compatible mixtures thereof; and compatible combinations thereof. The adhesive tape may be substantially free of silicone. The photoinitiator may comprise a visible light photoinitiator. The visible light photoinitiator may comprise 5, 7-diiodo-3-butoxy-6-fluorone. The adhesive layer may comprise at least about 45 wt. % of the curable material component, at least about 45 wt. % of the filler, and at least about 0.1 wt. % of the photoinitiator. The inert filler may comprise spherical silica. The photoinitiator may comprise a least one co-initiator. The adhesive layer may comprise about 49 wt. % maleimide functional hydrogenated rubber as the curable material component; about 50 wt. % silica as the inert filler; about 0.2 wt. % 5,7-diiodo-3-butoxy-6-fluorone as a visible-light photoinitiator; and about 0.3 wt. % ((4-octyloxy)phenyl(phenyl)iodonium hexafluoro antimonate) and about 0.3 wt. % butyryl choline butyl triphenyl borate as co-initiators. The backing may comprise a non-silicone polymer stable at least at 250° C. The backing may comprise a polyimide.

In some embodiments, a glass web has the adhesive tape adhered to at least one surface of the glass web. The adhesive tape may comprise an edge tape wrapped around at least one edge of the glass web. The glass web may comprise at least one of a leader or a trailer bonded to the glass web with the adhesive tape.

In some embodiments, a method comprises adhering a tape to a web of glass by contacting an adhesive layer of the tape with the web of glass. The tape comprises a backing sheet having first and second sides and the adhesive layer adhered to at least a portion of the first side. The adhesive layer comprises a curable material component, a photoinitiator component, and an inert filler. The method comprises exposing the tape to a processing temperature of at least 250° C. for a period of at least 5 minutes. The adhesive layer, when cured, is stable at 250° C. such that the tape remains adhered to the glass through the exposing step. The adhesive layer may be adhered to a trailing end of the web of glass. The backing may be stable and low outgassing from 250° C. to 350° C. The backing may comprise a polyimide polymer. The adhering step may comprise contacting the adhesive layer on the first side of the backing sheet to the leading end of the web of glass. The method may comprise adhering the adhesive layer on the first side of the backing sheet on at least one side edge of the web of glass, forming an edge tape. The adhering step may comprise at least partially curing the curable material component under an ultraviolet lamp. The tape may be substantially free of silicone. The adhering step may comprise fully curing the curable material component through the second side of the backing sheet of the tape to a soft, thermoset rubber. The tape may comprise a release liner adhered to the adhesive layer, and the method may comprise peeling off the release liner before adhering the adhesive layer on the first side of the backing sheet to the web of glass. The method may comprise depositing a layer of material onto the web of glass while exposing the adhered tape to a processing temperature of at least at 250° C. The layer of material may comprise indium tin oxide.

### Experimental Details:

The samples of adhesives were stored in freezers before they were taken out for testing. The samples were put into a sealed package. The sealed package was warmed to similar temperature as the temperature in the indium tin oxide chamber. Gas was generated inside the sealed package and was taken out to be tested.

Experiments were designed to replicate conditions observed in the Indium Tin Oxide (ITO) chamber. Thermal Gravimetrical Analysis (TGA), Fourier transform infrared spectroscopy (FTIR), and Gas chromatography- mass spectroscopy (GC-MS) were all used to measure the amount and species of material being outgassed from the adhesives. Mechanical tests were run to evaluate adhesive strength at elevated temperatures.

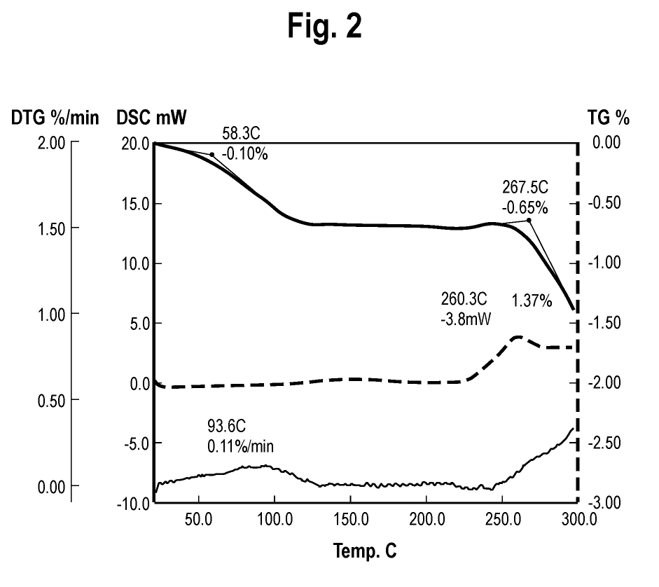

1. Analytical/Quantitative Analysis
a) TGA
Thermal Gravimetrical Analysis (TGA) was completed on all adhesives to weed out the potential candidates that degraded at any time from the onset of oxidation prior to reaching 250° C. The sample was tested to show how stable the sample is by heating the sample from 0° C. to 300° C. As shown FIG. 2, sample 16646-142-1 had shown a promising result. From the top curve, the onset of oxidation was slightly higher at 267.5° C. with a smaller weight loss of 1.37%. The initial, much smaller, onset may be seen around 58° C. is likely solvent loss.

b) GC-MS

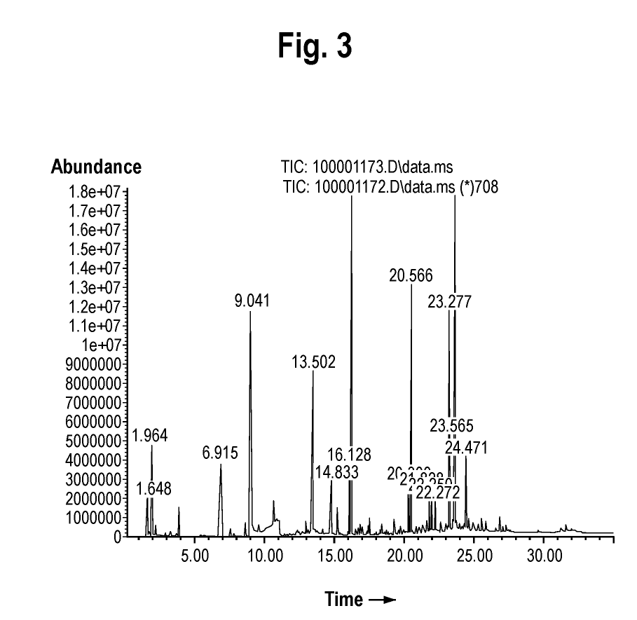

TD GC-MS was used to thermally break-down the adhesives and determine the components that out-gassed. No signs of silicone were found for the sample 16646-142-1. This is shown in chromatographs FIG. 3.

The retention time, identity, CAS number, and the relative abundance derived from the peaks of TD-GC/MS chromatogram of amber tape thermally desorbed at 250° C. for 30 minutes as shown in below table.

| | | | Relative |
|---|---|---|---|
| Retention | | | Abundance |
| Time (min.) | Identity | CAS# | (%) |
| 1.648 | Methane, iodo- | 000074-88-4 | 1.02% |
| 1.95 | Benzene | 000071-43-2 | 4.66% |
| 3.905 | Methanesulfonic acid, | 000066-27-3 | 1.01% |
| | methyl ester | | |
| 6.738 | Phenol | 000108-95-2 | 8.53% |
| 9.041 | 2-Propenoic acid, 2- | 002439-35-2 | 19.78% |
| | (dimethylamino)ethyl ester | | |
| 10.716 | 2-Phenoxyethyl isobutyrate | 103-60-6 | 0.71% |
| 13.504 | Biphenyl | 000092-52-4 | 4.05% |
| 14.838 | An unknown carbonyl and O | N/A | 2.28% |
| | containing compound | | |
| 15.243 | Butylated Hydroxytoluene | 000128-37-0 | 0.73% |
| 16.296 | Benzene, (octyloxy)- | 001818-07-1 | 17.16% |
| 17.518 | p-Hydroxybiphenyl | 000092-69-3 | 0.51% |
| 20.331 | Phenol, 4-dodecyl- | 000104-43-8 | 1.50% |
| 20.57 | An unknown aromatic, N and | N/A | 8.44% |
| | O containing compound | | |
| 21.827 | An unknown biphenyl | N/A | 1.02% |
| | containing compound | | |
| 22.058 | p-Terphenyl | 000092-94-4 | 1.04% |
| 22.273 | An unknown | N/A | 0.85% |
| 23.28 | An unknown aromatic, N and | N/A | 6.34% |
| | O containing compound | | |
| 23.568 | 9-Octadecenamide, (Z)- | 000301-02-0 | 4.03% |
| 23.712 | An unknown aromatic, N and | N/A | 14.26% |
| | O containing compound | | |
| 24.472 | Stearic acid chloride | 112-76-5 | 2.11% |

2. Mechanical Testing

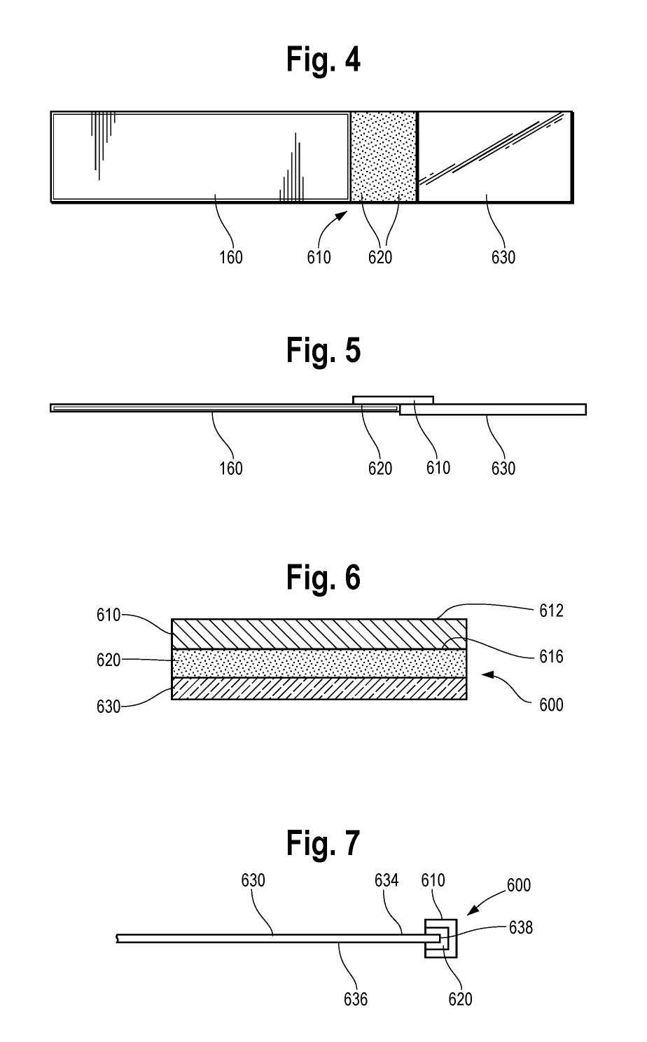

Samples were prepared in a class 10,000 cleanroom. Each sample consisted of 59.25 mm×104.75 mm×0.5 mm Eagle XG glass substrate, a 250 mm×59.25 mm×50 μm thick polyimide film trailer, and a 1.5 in×59.25 mm tape made for the adhesive in test and the polyimide film used for the trailer, assembled as shown in FIGS. 4 and 5. The samples were mounted in the heated Instron chamber such that the glass was held by the upper grip of the Instron and the polyimide film was held by the lower grip. A force was applied to the adhesive by the upper grip, attached to the glass, pulling upwards. This applies a shear force to the adhesive. All samples were pulled with a force of 6N for 15 minutes with an Instron with a chamber heated to either 250° C. or 300° C. The 6N force was designed to replicate the tension of 2N/inch (0.8 N/cm) the adhesive would see in the ITO deposition chamber. The Instron was programmed to pull at a consistent 6N force for 15 minutes or until failure. The extension (displacement, or movement of the adhesive) was measured as a function of time at the 6N force. Once samples survived the 15 minute 6N pull at 250° C., new samples of that adhesive were tested using the same pull force but at 300° C. Only the embodiments of the disclosure survived the 300° C. pull.

The glass used for the samples was cleaned with a cleaning line and packaged in a cleanroom. It was thought that possibly the decrease in adhesion was due to dirty glass. To verify this, clean glass was left in an office environment for 7 days to accumulate dust. The data collected from these samples was labeled dirty.

Once the clean and dirty samples were constructed, one of two scenarios would occur: either exposure to a prebake or no prebake. One set of each adhesive type experienced a 5 minute pre-bake at 250° C. or 300° C. (pull temperature) in the Instron chamber prior to applying force. Another set of the same adhesive type was loaded in the Instron chamber and the force was directly applied.

Minimizing slippage was very important for two reasons. First, if the adhesive slipped more on one side than the other, the torsion would be introduced to the glass web. This would increase likelihood of glass breaks. Secondly, if the glass is fed through a roll to roll process, any amount of exposed adhesive resulting from slippage may adhere to the rollers and then transfer to the glass repeatedly, possibly contaminating an entire roll.

Experimental results had shown that the clean glass samples of adhesive performed better than the samples made with dirty glass. The samples made with clean glass slipped an average of 1.37 mm versus the dirty glass with a slippage of 1.51 mm.

Additional samples were prepared by baking the adhesive after it was applied to the glass but before any force was applied. These samples were referred to as prebaked samples. The samples that were loaded directly into the grips in the 250° C. or 300° C. Instron chamber without a prior bake were termed non-prebaked samples.

The difference observed between the samples with adhesives that received the prebake and the samples with adhesives that did not receive the prebake was very small. The prebaked sample showed an average slippage of 1.29 mm with the non-prebake samples slipping 1.37 mm.

In an effort to prove the exemplary adhesive would indeed hold lamination during exposure to heat for a longer period of time, the Instron was programed to cycle through 15 minute 2N/inch (0.8 N/cm) force until failure or 10 hours was reached. In the case of both the non-Prebaked samples of adhesive, the adhesive held for 10 hours with minimal slippage, less than 0.4 mm.

It will be apparent to those skilled in the art that the methods and apparatuses disclosed herein could be applied to a variety of structures having different geometries and to create selectively coated and uncoated portions of varying shapes, sizes, and orientations. It will also be apparent to those skilled in the art that various modifications and variations can be made without departing from the spirit or scope of the invention.

1. A composition of matter comprising the following components or a mixture or a reaction product thereof:
a curable material component comprising a compound having the structure: 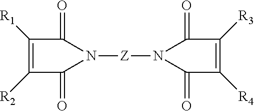
wherein Z is a backbone of a completely or substantially completely hydrogenated hydrocarbon based rubber material, and R₁, R₂, R₃ and R₄ are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, or acrylate;
a photoinitiator component having substantially no volatility at room temperature and yielding photoproducts after exposure to photo radiation, the photoproducts having substantially no volatility at room temperature; and
an inert filler,
wherein the composition, when cured, is stable at 250° C. and is low outgassing.

2. The composition of claim 1, wherein at least one of R₁ and R₂ combine to form a ring or R₃ and R₄ combine to form a ring.

3. The composition of claim 1, wherein the inert filler comprises an inorganic filler selected from the group consisting of alumina, crystobalite, aluminum trihydroxide, talc, feldspar, calcium carbonate, mica, clay, wallastonite, nepeleline syenite, silica, compatible mixtures thereof, and compatible combinations thereof.

4. The composition of claim 1, wherein the photoinitiator comprises at least one compound selected from the group consisting of:
oligo [2-hydroxy-2-methyl-1-[4-(1-methylvinyl)phenyl]propanone],
oligo [2-hydroxy-2-methyl-1-[4-(1-methylvinyl)phenyl]propanone], diluted in tripropylene glycol diacrylate (25% TPGDA);
1-[4-(4-benzoylphenylsulfonyl)phenyl]-2-methyl-2-(4-methylphenylsulfonyl) propan-1-one;
bis(2,4,6-trimethylbenzoyl)-phenyl phosphine oxide;
2-benzyl-2-N, N-dimethylamino-1-(4-morpholino-phenyl)-1-butanone;
bis η5-(2,4-cyclopentadien-1-yl) bis(2,6-difluoro-3-(1H-pyrrol-1-yl) phenyl)titanium;
bis (2,6-dimethoxybenzoyl)-2,4,4-trimethylpentyl phosphine oxide;
2-oxepanone, homopolymer, 2-[[4-[2-methyl-2-(4-morpholinyl)-1-oxopropyl]phenyl]thio]ethyl ester;
2-isopropylthioxanthone;
4-isopropylthioxanthone;
1,3-dimethyl-2-hydroxy-9H-thioxanthen-9-one, 2-ethylhexyl ester;
4,4′-bis(methylethylamino)benzophenone;
4,4′-bis(isopropylphenoxy)benzophenone;
4-benzoyl-4′-methyldiphenyl sulfide;
2-chloro-th ioxanthone;
1-chloro-4-propoxythioxanthone;
2,4-diethylthioxanthone;
poly[oxy(methyl-1,2-ethanediyl)], α-[4-(dimethylamino)benzoyl-ω-butoxy-,
2,2′-bis-(2-chlorophenyl)-4,5,4′,5′-tetraphenyl-2′H-<1,2′>biimidazolyl,
(tolylcumyl)iodonium tetrakis(pentafluorophenyl) borate;
[4-[(2-hydroxytetradecyl)oxy]phenyl]phenyliodoniurn hexafluoro antimonate,
bis(4-dodecylphenyl)iodonium hexafluoroantimonate,
isopropylthioxanthone,
C12+C14 alkylglycidyl ethers;
phenyl-4-octyloxyphenyl iodonium hexafluoro antimonate;
triaryl sulfonium hexafluoroantimonate salts;
mixture of triaryl sulfonium hexafluorophosphate salts;
5,7-diiodo-3-butoxy-6-fluorone,
perylene;
anthracene,
1,2-benzanthracene,
9-n-butoxyanthracene;
9,10-di-n-butoxy anthracene;
9,10-di-n-propoxy anthracene;
9,10-diethoxy anthracene;
enthrone;
pyrene,
2-ethyl-9, 10-dimethoxy anthracene;
2,5-diphenyl-1,3,4-oxadiazole,
diphenyl anthracene;
9,10-dimethylanthracene,
1,3-diphenyl-2-pyrazoline,
1,3-diphenylisobenzofuran,
N,N,N′,N′-tetraphenyl benzidine; and
N,N,N′,N′-tetraphenyl phenylene diamine;
compatible mixtures thereof; and compatible combinations thereof.

5. The composition of claim 1, wherein the composition is substantially free of silicone.

6. The composition of claim 1, wherein the photoinitiator comprises a visible light photoinitiator.

7. The composition of claim 6, wherein the visible light photoinitiator comprises 5, 7-diiodo-3-butoxy-6-fluorone.

8. The composition of claim 1, wherein Z does not have an ether group.

9. The composition of claim 1, comprising at least about 45 wt. % of the curable material component, at least about 45 wt. % of the filler, and at least about 0.10 wt. % of the photoinitiator.

10. The composition of claim 1, wherein the inert filler comprises spherical silica.

11. The composition of claim 1, wherein the photoinitiator comprises at least one co-initiator.

12. The composition of claim 1, wherein Z does not have epoxy group.

13. The composition of claim 1, comprising:
about 49 wt. % maleimide functional hydrogenated rubber as the curable material component;
about 50 wt. % silica as the inert filler;
about 0.2 wt. % 5,7-diiodo-3-butoxy-6-fluorone as a visible light-photoinitiator; and
about 0.3 wt. % ((4-octyloxy)phenyl(phenyl)iodonium hexafluoro antimonate) and about 0.3 wt. % butyryl choline butyl triphenyl borate as co-initiators.

14. A method for producing the composition of claim 1, the method comprising:
(a) milling the photoinitiator component and the inert filler with the curable material component to form a precurable mixture; and
(b) at least partially curing the precurable mixture by ultraviolet light forming an at least partially cured material,
wherein the at least partially cured material is stable at least at 250° C. and is low outgassing.

15. The method of claim 14, further comprising fully curing the at least partially cured material by ultraviolet light.

16. (canceled)

17. An adhesive tape comprising:
an adhesive layer having first and second sides and comprising the composition of claim 1; and
a backing attached to the first side of the adhesive layer.

18-20. (canceled)

21. A glass web with the adhesive tape of claim 17 adhered to at least one surface of the glass web.

22. The glass web of claim 21, wherein the adhesive tape comprises at least one of:
an edge tape wrapped around at least one edge of the glass web;
a leader bonded to the glass web with the adhesive tape; or
a trailer bonded to the glass web with the adhesive tape.

23. (canceled)

24. A method comprising:
adhering a tape to a web of glass by contacting an adhesive layer of the tape with the web of glass, the tape comprising a backing sheet having first and second sides and the adhesive layer adhered to at least a portion of the first side, the adhesive layer comprising a curable material component, a photoinitiator component, and an inert filler; and
exposing the tape to a processing temperature of at least 250° C. for a period of at least 5 minutes;
wherein the adhesive layer, when cured, is stable at 250° C. such that the tape remains adhered to the glass through the exposing step.

25. The method of claim 24, wherein the adhering step further comprises at least partially curing the curable material component under an ultraviolet lamp.

26. The method of claim 24, wherein the adhering step further comprises fully curing the curable material component through the second side of the backing sheet of the tape to a soft, thermoset rubber.

27. The method of claim 24, wherein the exposing step comprises depositing a layer of indium tin oxide onto the web of glass.

28. The method of claim 24, wherein the backing is stable and low outgassing from 250° C. to 350° C.

29. The method of claim 24, wherein the backing comprises a polyimide polymer.

30. The method of claim 24, wherein the tape is substantially free of silicone.
